(19) United States
(12) Patent Application Publication
(10) Pub. No.: US 2013/0112606 A1
(43) Pub. Date: May 9, 2013

(54) FILTER ASSEMBLY FOR FLUID PATH AND METHOD OF MANUFACTURE

(71) Applicant: Medical Components, Inc., Harleysville, PA (US)

(72) Inventor: Mark S. Fisher, Sellersville, PA (US)

(73) Assignee: MEDICAL COMPONENTS, INC., Harleysville, PA (US)

(21) Appl. No.: 13/667,037

(22) Filed: Nov. 2, 2012

Related U.S. Application Data
(60) Provisional application No. 61/556,373, filed on Nov. 7, 2011.

(51) Int. Cl. B01D 63/00

(52) U.S. Cl. CPC B01D 63/00
USPC 210/248; 210/321.72; 29/428

(57) ABSTRACT

A filter assembly including a first body section having a first through passage with a seat defined about the through passage and including a first membrane-engaging surface and a central platform with the central platform extending about the first through passage. A second body section has a second through passage and defines a second membrane-engaging surface and a recess about the second through passage. A filter membrane is disposed within the filter membrane seat and the first and second body sections are secured to one another with a central portion of the filter membrane received within the recess and supported on the platform surface in a first plane and traversing the through passages and a peripheral portion of the filter membrane secured between the first and second membrane-engaging surfaces in a second plane spaced from the first plane.

This application claims the benefit of U.S. Provisional Application No. 61/556,373 filed on Nov. 7, 2011, the contents of which are incorporated herein by reference.

### FIELD OF THE INVENTION

The present invention relates to the field of fluid flow and more particularly to a filter assembly for a fluid flow path.

### BACKGROUND OF THE INVENTION

It is desirable to provide a filter assembly for placement in a fluid flow path of a conduit arrangement, where the filter is a membrane defining small apertures to capture small debris. Such a filter membrane may be delicate and easily distorted or wrinkled in shape when clamped or fixed in place in a filter assembly such that the filter membrane's apertures are changed undesirably in size and/or shape. Accordingly, a method and device for providing a filter assembly using a delicate filter membrane without undue distortion, is desirable.

### BRIEF SUMMARY OF THE INVENTION

Briefly, the present invention provides a filter assembly housing having upstream and downstream ends with a passageway extending therebetween for the flow of a fluid. A filter membrane is firmly positioned within the housing, traversing the passageway. Preferably, the filter membrane is woven of material such as nylon and having apertures of pre-selected dimension, one non-limited example including micropores.

In at least one embodiment of the invention, the filter assembly comprises a first body section having a first through passage with a seat defined about the through passage. The seat includes a first membrane-engaging surface and a central platform with the central platform extending about the first through passage and defining a platform surface spaced from the membrane-engaging surface. A second body section has a second through passage and defines a second membrane-engaging surface and a recess about the second through passage with the recess defining a surface recessed from the second membrane-engaging surface. A filter membrane is disposed within the filter membrane seat and the first and second body sections are secured to one another with the first and second through passages aligned and a central portion of the filter membrane received within the recess and supported on the platform surface in a first plane and traversing the through passages and a peripheral portion of the filter membrane secured between the first and second membrane-engaging surfaces in a second plane spaced from the first plane.

In at least one embodiment of the invention, the filter assembly includes a first body section having a first through passage with a first membrane-engaging surface defined about the first through passage and a first peripheral ledge about the first membrane-engaging surface. A second body section has a second through passage with a second membrane-engaging surface defined about the second through passage and a second peripheral ledge about the second membrane-engaging surface. The first and second body sections are positioned relative to one another in an initial position with a filter membrane uncompressed between the first and second membrane-engaging surfaces. The first and second body sections are moved toward each other a given travel distance to a final position wherein at least a portion of the filter membrane is compressed a desired amount between the first and second membrane-engaging surfaces. In the initial position the peripheral ledges are spaced from one another at an initial ledge distance and after final assembly a predetermined final ledge distance, equal to the initial ledge distance minus the given travel distance, is defined between the peripheral ledges.

In one or more of the embodiments, the filter assembly is manufactured in a way such the act of assembly does not distort the filter membrane to preserve the apertures of the filter membrane portion traversing the passageway against being wrinkled and/or otherwise distorted from their pre-selected dimensions and configurations.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIGS. 1 and 2 are assembled and exploded isometric views of the filter assembly of an exemplary embodiment of the present invention;

FIGS. 3 and 4 are exploded elevation and cross-sectional views of the filter assembly of FIG. 2, with FIG. 4 taken along lines 4-4 of FIG. 3;

FIG. 5 is a plan view of the filter membrane of FIGS. 1 to 4;

FIGS. 6 and 7 are enlarged views of the mating interface before and after assembly; and

FIGS. 8 and 9 are expanded views of portions of the mating interface, as indicated in FIGS. 6 and 7 respectively, before and after assembly.

FIG. 10 is a schematic drawing illustrating an exemplary relationship of the initial distance cdi between the contact points and the final distance cdf between the contact points.

### DETAILED DESCRIPTION OF THE INVENTION

In the drawings, like numerals indicate like elements throughout. Certain terminology is used herein for convenience only and is not to be taken as a limitation on the present invention. The terms and expressions used herein, and the embodiments illustrated below, are not intended to be exhaustive or to limit the invention to the precise form disclosed. These terms, expressions and embodiments are chosen and described to best explain the principle of the invention and its application and practical use and to enable others skilled in the art to best utilize the invention.

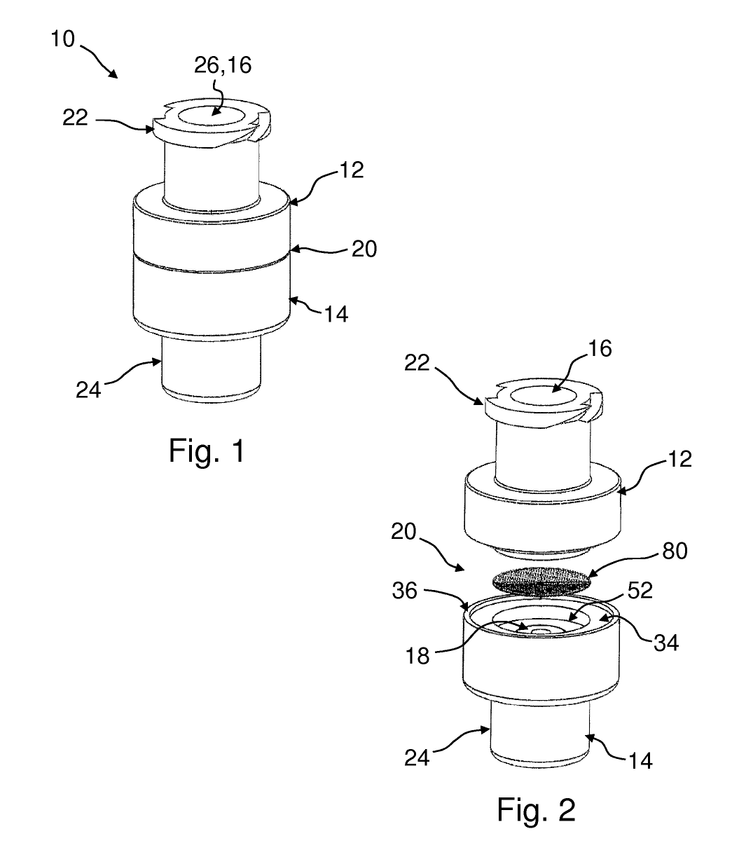

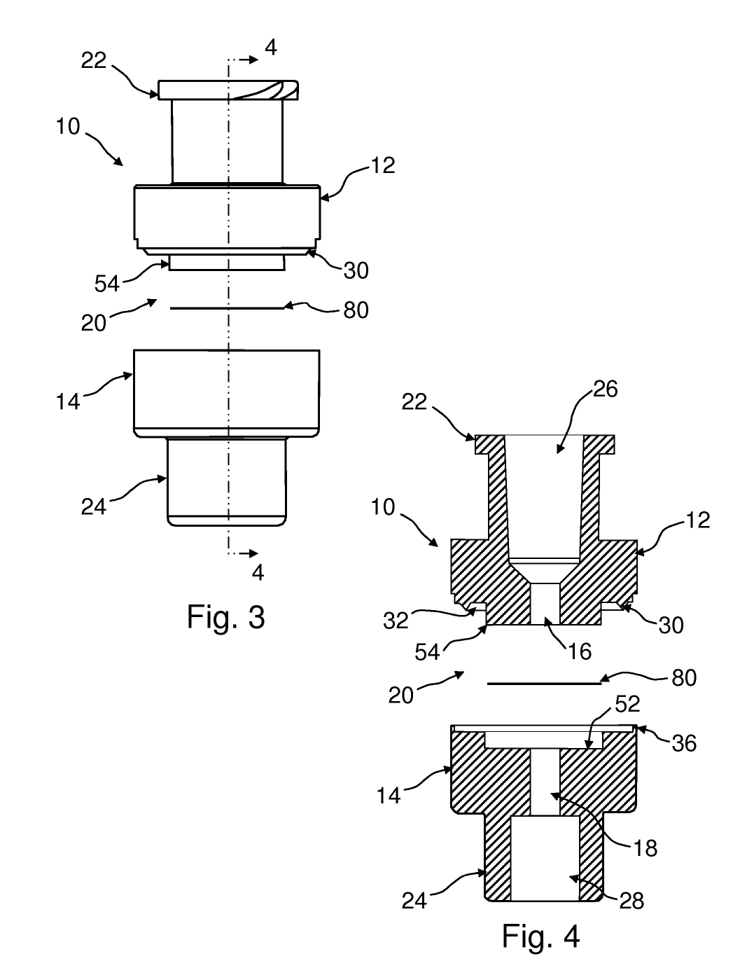

A filter assembly 10 in accordance with an exemplary embodiment of the invention will be described with reference to the figures. Referring to FIGS. 1 to 4, the exemplary filter assembly 10 generally includes a housing or hub having two body sections 12,14 that are assembled together along a mating interface 20 during manufacture, encapsulating therebetween a filter membrane 80 within the mating interface. The body sections 12,14 have respective passageways 16,18 therethrough aligned to provide a fluid flow path, and the filter membrane 80 traverses the fluid flow path after assembly for filtering debris from the fluid during use. Each body section 12, 14 includes a coupling end 22,24 respectively, with which the filter assembly 10 is to be coupled to ends of respective conduits (not shown) in conventional manner, with each coupling end 22,24 including an entrance 26,28 to the respective passageway 16,18 of that body section. The body sections 12,14 may be made, for example, of polypropylene, biocompatible material, or any other desired material.

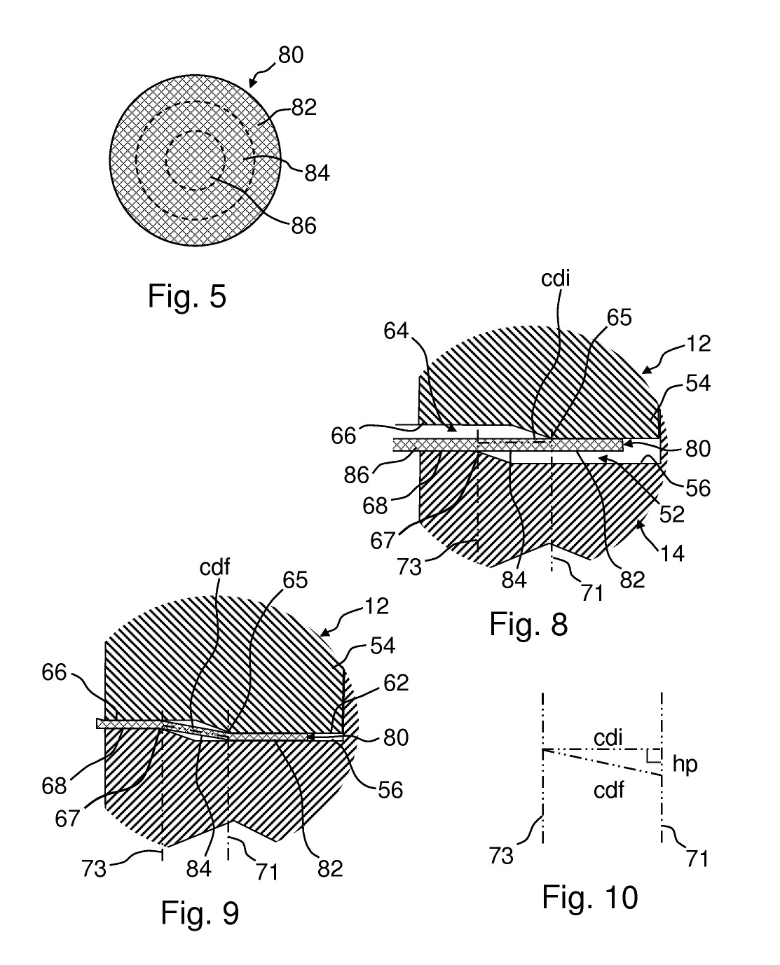

Filter membrane 80 may have various configurations. In the illustrated embodiment, the filter membrane 80 is relatively thin and comprises, for example, a fabric woven of nylon filaments. Other filter materials may also be utilized. Prior to assembly of the filter assembly 10, which as explained below compresses at least portions of the filter membrane 80, the filter membrane 80 has a given initial thickness Ti (see FIG. 6). The initial thickness Ti of filter membrane 80 is preferably uniform across the structure, but may be varied if desired. In an exemplary application in which the filter membrane 80 acts as a microfilter, the initial thickness Ti may be about, for example, 0.002 inches (0.0490 mm) and the apertures between the woven filaments may be about 10 microns, for example, in their largest transverse dimension. Thus, the filter membrane is microporous and will capture particles of debris larger than about for example, above 10 microns, in their largest transverse dimension. Filter membrane 80 is shown in FIG. 5 to have a peripheral portion 82, a central portion 86 and an annular intermediate portion 84 therebetween.

Referring to FIGS. 2, 4, 6 and 7, the mating interface 20 includes a filter membrane seat 52, whereat the filter membrane 80 is disposed prior to joining of the first and second body sections 12,14. In the illustrated embodiment, the body sections 12,14 are joined to each other along the mating interface 20 through an ultrasonic welding process, although other process may be used. First body section 12 is shown to have an annular welding ridge 30 surrounding the filter membrane seat 52, projecting from a welding ledge 32 toward a target welding surface 34 of second body section 14. Welding ridge 30 serves to direct the ultrasonic energy. While the welding ridge 30 is illustrated as triangular in cross-section, the welding ridge 30 may have any desired configuration, e.g. square or rivet, as is known in the art. Upon application of ultrasonic energy, the welding ridge 30 melts and flows (see FIG. 7) laterally along a gap between the facing surfaces of the welding ledge 32 and target welding surface 34 as the body sections 12, 14 are pressed against each other, forming a weld joint 40. Target welding surface 34 is shown surrounded by a flange 36 that provides weld flow containment. Outwardly of welding ridge 30 and target welding surface 34 are peripheral transverse surfaces 37, 38, which are discussed hereinbelow.

Inwardly of the target welding surface 34, the second body section 14 defines the filter membrane seat 52 containing therein the filter membrane 80 disposed transversely. The first body section 12 includes a complementary filter-engaging flange 54 dimensioned and shaped to fit within the seat 52. The dimensions of the flange 54 and the seat 52 are preferably complementary with little clearance to thus center the first and second body sections 12,14 during assembly, as seen in FIGS. 6 and 7.

Referring to FIGS. 6 to 9, the filter membrane seat 52 includes a membrane-engaging surface 56 with a raised platform 60 centrally located therein and having a platform top surface 68 surrounding the passageway 18 upon which the central portion 86 of the filter membrane 80 will be disposed. The raised platform 60 preferably tapers from the membrane-engaging surface 56 to the platform top surface 68 such that the platform 60 has an outer diameter odp adjacent the surface 56 and tapers to an inner diameter idp adjacent the top surface 68. The raised platform 60 has a height hp which is dimensioned based on various characteristics of the filter membrane 80, for example, the thickness, the material, the flexibility, the tensile strength.

The membrane-engaging surface 62 of filter-engaging flange 54 of first body section 12 defines a corresponding, co-axial central recess 64. The central recess 64 preferably tapers from the membrane-engaging surface 62 to a recessed surface 66 such that the recess 64 has an outer diameter odr adjacent the surface 62 and tapers to an inner diameter idr adjacent the recessed surface 66. The recess 64 has a depth hr which is preferably equal to the platform height hp such that the central portion 86 of the filter membrane 80, which is aligned with the platform top surface 68, is compressed between the platform top surface 68 and the recessed surface 66 when the first and second body sections 12,14 are pressed together, as described hereinafter. Additionally, it is preferred that the recess inner diameter idr is larger than the platform inner diameter idp and the recess outer diameter odr is larger than the platform outer diameter odp such that the intermediate portion 84 of the filter membrane 80 is not compressed, but instead is tensilely stretched as described hereinafter.

Referring to FIGS. 6 and 8, the body sections 12, 14 and the filter membrane 80 are in an initial position, defined herein by the welding ridge 30 in initial contact with the target welding surface 34, but no axial force applied between the body sections 12, 14. The height of the welding ridge 30 thereby defines the initial distance d2i between the welding ledge 32 and the target welding surface 34. Radially outward of the welding ridge 30, the top surface 37 of annular peripheral flange 36 and the associated peripheral ledge 38 of first body section 12 are spaced from one another by an initial distance d1i. The relationship of the various distances will be described hereinafter.

In the initial position, the seat 52, flange 54, raised platform 60 and the filter membrane 80 are preferably configured such that the filter membrane is in a substantially free state without force, other than gravity, acting thereon. In this regard, the initial distance d3i between the membrane-engaging surfaces 56 and 62 is equal to or slightly greater than the platform height hp plus the initial membrane thickness Ti. With reference to FIG. 8, in this initial position, the filter membrane 80 central portion 86 sits on the platform top surface 68, and the intermediate portion 84 is contacted by the platform 60 at circumferential point 67 at radius 73 and the flange 54 at circumferential point 65 at radius 71. Measuring along the filter membrane 80, which is perpendicular to the radius planes 71, 73, the intermediate portion 84 of the filter membrane 80 extends an initial distance cdi between the contact points 65, 67 in the initial position. Radially outward from the contact point 65, the peripheral portion 82 of the filter membrane 80 extends along the adjacent-membrane surface 62. As explained hereinafter, as the body sections 12, 14 are pressed together, the contact point 65 engages the filter membrane 80 and prevents the peripheral portion 82 from migrating inward.

As another initial relationship, the initial distance d4i between the platform top surface 68 and the recessed surface 66 is preferably less than the initial membrane thickness Ti plus the distance of travel TD, as will be defined, such that upon final assembly of the body sections 12, 14, the central portion 86 of the membrane 80 will be positioned between the surfaces 66, 68 with a desired amount of compression of the central portion 86 of the filter membrane 80 aligned with the surfaces 66, 68. The amount of compression may be equal to, more than or less than the compression of the peripheral portion 82 and the distance d4i can be configured accordingly. In some applications, it is also possible that no compression of the central portion 86 is desired, in which case, the initial distance d4i between the platform top surface 68 and the recessed surface 66 will equal to or greater than the initial membrane thickness Ti plus the distance of travel TD.

In the present embodiment, the body sections 12,14 are assembled together via ultrasonic welding wherein ultrasonic energy is applied while the body sections 12,14 are pressed toward one another. Other joining methods may alternatively be utilized wherein the body sections 12,14 are bonded to one another as they are moved toward each other.

FIGS. 7 and 9 show the filter assembly 10 in the final assembled condition. During the assembly, the body sections 12,14 are moved toward one another a given travel distance TD, as indicated in FIG. 7. As the body sections 12,14 are moved together, it is preferable that a final distance d2_{f} remains between the welding ledge 32 and the target welding surface 34 to provide an overflow containment area for the melting welding ridge 30. Accordingly, the given travel distance TD should be equal to the initial distance d2ᵢ minus the desired final distance d2_{f}. By controlling the travel distance to equal the given travel distance TD, an overflow containment area with the height of d2_{f} is assured. By basing the given travel distance TD off of the initial distance d2ᵢ, which is equivalent to the height of the welding ridge 30, the welding ridge 30 configuration can be selected as needed to achieve a desired joining and then the other relationships may be established as described below. However, the invention is not limited to such, and another relationship may be utilized as the initial relationship upon which the other relationships are based.

The distance d1 between the top surface 37 of annular peripheral flange 36 and the associated peripheral ledge 38 of first body section 12 is preferably used to control the travel distance. To assure the given travel distance TD, the final distance d1_{f} is selected as a predetermined value equal to the initial distance d1_{f} minus the given travel distance TD. A gauge or the like may be utilized to determine when the predetermined d1_{f} value has been reached. The predetermined d1_{f} value is equal to or greater than zero, and may be for example, 0.002 in (0.051 mm). Once the predetermined d1_{f} value has been reached, the given travel distance TD has been achieved and further relative movement between the body sections 12,14 is preferably stopped.

The configuration of the seat 52, the flange 54 and the filter membrane 80 are preferably associated with the given travel distance TD such that a desired engagement of the filter membrane 80 is achieved. As illustrated in FIGS. 7 and 9, after final assembly, the peripheral portion 82 of the filter membrane 80 is preferably compressed to have a final thickness T_{f} which is less than the initial thickness Tᵢ whereby the filter membrane 80 is held in place between the membrane-engaging surfaces 56, 62. The ratio of the final thickness T_{f} to the initial thickness Tᵢ may be any desired ratio. The final thickness T_{f} will be equal to the final distance d3_{f} between the membrane-engaging surfaces 56, 62. Accordingly, to achieve a desired final thickness T_{f}, the initial distance d3ᵢ is configured equal to the desired final thickness T_{f} plus the given travel distance TD.

As explained above, it is preferred that the portion of the central portion 86 of the filter membrane 80 not aligned with the through passages 16, 18 is compressed to some extent upon final assembly to a thickness less than the initial thickness Tᵢ. The final thickness of the central portion 86 not aligned with the through passages 16,18 will be defined by the final distance d4_{f} between the platform top surface 68 and the recessed surface 66. Accordingly, to achieve a thickness less than the initial thickness Tᵢ, the initial distance d4ᵢ is configured to be less than the initial thickness Tᵢ plus the given travel distance TD. As explained above, in some applications it may be desirable to not compress any of the central portion 86 and the distance d4i can be increased accordingly.

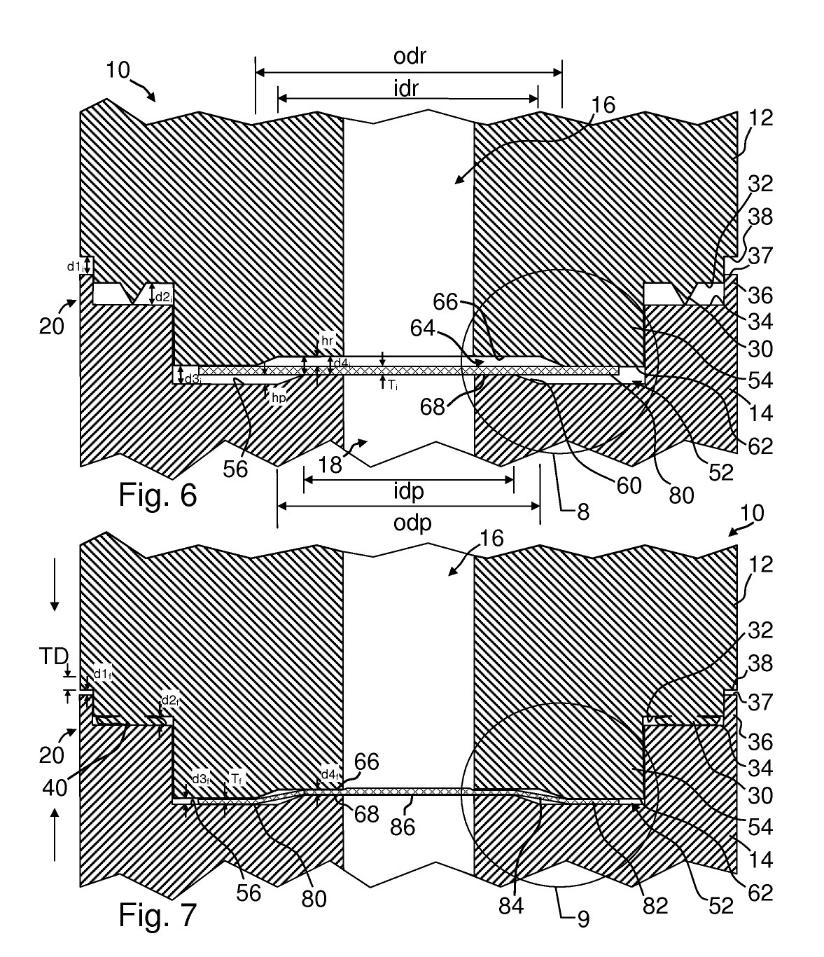

As will be described, the configuration of the platform 60 and the recess 64 also cause the intermediate and central portions 84, 86 of the filter membrane 80 to be slightly tensioned during assembly thereby minimizing wrinkling or the like of the central portion 86, without distorting the apertures therethrough. As shown in FIGS. 7 and 9, as the body sections 12,14 move together, the contact point 65 engages the filter membrane 80 at the junction between the intermediate portion 84 and the peripheral portion 82. As such, the peripheral portion 82 is maintained in its radial position and compressed between the membrane-engaging surfaces 56, 62. The relative movement between the body sections 12, 14, particularly when the final distance d3_{f} between the membrane-engaging surfaces 56, 62 becomes less than the platform height hp, causes the contact points 65, 67 to move relative to one another such that the distance between the points, measured along the membrane therebetween, is increased to a final distance between the contact points cd_{f}. As shown in FIG. 10, the final contact distance cd_{f} represents the hypotenuse of a right triangle with the initial contact distance cdᵢ and the platform height hp as the legs thereof and therefore is equal to the square root of cdᵢ² plus hp² and is by definition larger than the distance cdᵢ².

Increasing the contact distance causes a tensile force on the intermediate and central portions 64, 86 of the filter membrane 80. Since the intermediate and central portions 64, 86 of the filter membrane 80 are substantial free, based on d4ᵢ and the idp/idr and odp/odr relationships, the tensile force causes the intermediate and central portions 84, 86 of the membrane 80 to smooth over the platform. The initial contact distance cdᵢ and the platform height hp may be configured to achieve a desired final contact distance cd_{f} and corresponding tension. The desired amount of tension will be dependent on the characteristics of the filter membrane 80.

Importantly, the apertures through the microporous filter membrane 80, at least where the membrane traverses the passageways, should not become distorted or, especially, enlarged during the assembly process, and the membrane cannot contain wrinkles after assembly; thus the membrane's filtering integrity can be assured and reliably rated.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A filter assembly comprising:
a first body section having a first through passage with a seat defined about the through passage, the seat including a first membrane-engaging surface and a central platform, the central platform extending about the first through passage and defining a platform surface spaced from the membrane-engaging surface;
a second body section having a second through passage and defining a second membrane-engaging surface and a recess about the second through passage, the recess defining a surface recessed from the second membrane-engaging surface; and
a filter membrane disposed within the filter membrane seat, wherein the first and second body sections are secured to one another with the first and second through passages aligned and a central portion of the filter membrane received within the recess and supported on the platform surface in a first plane and traversing the through passages, and a peripheral portion of the filter membrane secured between the first and second membrane-engaging surfaces in a second plane spaced from the first plane.

2. The filter assembly of claim 1 wherein the filter membrane is woven of filaments.

3. The filter assembly of claim 1 wherein the second body section includes a flange which defines the second membrane-engaging surface and the recess, and wherein the flange is configured to be received within seat.

4. The filter assembly of claim 1 wherein the membrane-engaging surfaces compressively engage the peripheral portion of the filter membrane upon assembly.

5. The filter assembly of claim 4 wherein upon assembly, the platform surface and the recessed surface are spaced such that the central region of the filter membrane between the surfaces is compressed to the same degree as the compression of the peripheral portion.

6. The filter assembly of claim 4 wherein upon assembly, the platform surface and the recessed surface are spaced such that the central region of the filter membrane between the surfaces is compressed to a degree less than the compression of the peripheral portion.

7. The filter assembly of claim 1 wherein the platform tapers from the first membrane-engaging surface such that the platform has an outer platform diameter at the first membrane-engaging surface and an inner platform diameter at the platform surface and wherein the recess is tapered such that the recess has an outer recess diameter at the second membrane-engaging surface and an inner recess diameter at the recessed surface, and wherein the inner recess diameter is larger than the inner platform diameter and the outer recess diameter is larger than the outer platform diameter.

8. The filter assembly of claim 7 wherein an intermediate portion of the filter membrane between the peripheral portion and the central portion is aligned between the inner platform diameter and the outer recess diameter and remains free from compressing engagement upon final assembly.

9. The filter assembly of claim 8 wherein the intermediate and central portions of the filter membrane are subjected to a tensile force upon final assembly.

10. The filter assembly of claim 1 wherein the first and second body sections are ultrasonically welded to each other surrounding the filter membrane seat, enclosing the filter membrane therebetween within the completed assembly and sealing the assembly.

11. The filter assembly of claim 10 wherein second first body section includes a transverse welding ledge surrounding the second membrane-engaging surface, the welding ledge including an annular welding ridge for directing the ultrasonic energy, and the first body section defines a transverse annular target welding surface about the first membrane-engaging surface.

12. The filter assembly of claim 11 wherein the welding ridge has an initial height which defines an initial weld surface distance between the welding ledge and the target welding surface, and during assembly the first and second body sections are moved toward one another a given travel distance at which point final assembly is achieved, the given travel distance being less than the initial weld surface distance such that an overflow reservoir is defined between the welding ledge and the target welding surface.

13. The filter assembly of claim 1 wherein the first body section defines a first peripheral ledge and the second body section defines a second peripheral ledge opposite the first peripheral ledge, and wherein a predetermined final ledge distance between the peripheral ledges defines when final assembly of the body sections has been achieved.

14. The filter assembly of claim 13 wherein the final ledge distance is equal to zero.

15. The filter assembly of claim 13 wherein the final ledge distance is equal to a distance greater than zero.

16. The filter assembly of claim 13 wherein prior to assembly, the first and second body sections are positioned relative to one another in an initial position, and wherein in the initial position the peripheral ledges are spaced from one another at an initial ledge distance.

17. The filter assembly of claim 16 wherein during assembly the first and second body sections are moved toward one another a given travel distance equal to the initial ledge distance minus the final ledge distance.

18. The filter assembly of claim 17 wherein at the initial position, the first and second member-engaging surfaces are spaced from one another an initial engaging surface distance equal to the given travel distance plus an intended final thickness of the peripheral portion of the filter membrane.

19. The filter assembly of claim 18 wherein at the initial position, the platform surface and the recessed surface are spaced from one another an initial platform surface distance equal to the given travel distance plus an intended final thickness of the central portion of the filter membrane.

20. A filter assembly comprising:
a first body section having a first through passage with a first membrane-engaging surface defined about the first through passage and a first peripheral ledge about the first membrane-engaging surface;
a second body section having a second through passage with a second membrane-engaging surface defined about the second through passage and a second peripheral ledge about the second membrane-engaging surface; and
a filter membrane, wherein the first and second body sections are positioned relative to one another in an initial position with the filter membrane uncompressed between the first and second membrane-engaging surfaces and the first and second body sections are moved toward each other a given travel distance to a final position wherein at least a portion of the filter membrane is compressed a desired amount between the first and second membrane-engaging surfaces, and wherein in the initial position the peripheral ledges are spaced from one another at an initial ledge distance and after final assembly a predetermined final ledge distance, equal to the initial ledge distance minus the given travel distance, is defined between the peripheral ledges.

21. The filter assembly of claim 20 wherein the final ledge distance is equal to zero.

22. The filter assembly of claim 20 wherein the final ledge distance is equal to a distance greater than zero.

23. A method of assembling a filter assembly for a fluid flow path, comprising the steps of:
positioning a filter membrane, having an initial thickness, relative to a first body section such that the filter membrane traverses a first through passage defined by the first body section, the first body section including a first membrane-engaging surface about the first through passage and a first peripheral ledge about the first membrane-engaging surface;
positioning a second body section relative to the first body section such that a second through passage defined by the second body section is aligned with the first through passage, a second membrane-engaging surface defined by the second body section is aligned with and spaced from the first membrane-engaging surface by an initial engaging surface distance, and a second peripheral ledge defined by the second body surface is aligned with and spaced from the first peripheral ledge by an initial ledge distance;
moving the first and second body sections toward one another until a predetermined final ledge distance between the first and second peripheral ledges; and
securing the first and body sections relative to one another with the first and second peripheral ledges are spaced from one another by the final ledge distance;
wherein the first and second body sections move a travel distance equal to the initial ledge distance minus the final ledge distance and wherein the initial engaging surface distance is less than the travel distance plus the filter membrane initial thickness such that at least a portion of the filter membrane is compressed a desired amount between the first and second membrane-engaging surfaces.

24. The method of claim 23 wherein the step of securing first and second body sections relative to one another includes welding.

25. The method of claim 24 wherein the first and second body sections are ultrasonically welded to each other as the first and second body sections are moved relative to one another.

26. A method of assembling a filter assembly for a fluid flow path, comprising the steps of:
positioning a filter membrane, having an initial thickness, relative to a first body section such that a central portion of the filter membrane is supported in a first plane by a platform surface of a first body section seat and traverses a first through passage defined by the first body section, and a peripheral portion of the filter membrane is aligned with a first membrane-engaging surface which extends about the platform in a second plane spaced from the first plane by a platform height;
positioning a second body section relative to the first body section such that a second through passage defined by the second body section is aligned with the first through passage, a second membrane-engaging surface defined by the second body section is aligned with and spaced from the first membrane-engaging surface by an initial engaging surface distance, and a recessed surface defined by the second body surface is aligned with and spaced from the platform surface by an initial platform distance, the initial platform distance being larger than the initial engaging surface distance;
moving the first and second body sections toward one another until a final engaging surface distance between the first and second membrane-engaging surfaces is less than the platform height and less than the initial thickness of the filter membrane; and
securing the first and body sections relative to one another with the first and second membrane-engaging surfaces spaced from one another by the final engaging surface distance.
